(19) United States
(12) Patent Application Publication
(10) Pub. No.: US 2009/0030840 A1
(43) Pub. Date: Jan. 29, 2009

(54) METHOD FOR LIMITING DEBIT CARD TRANSACTIONS

(76) Inventor: Larry J. KANE, Marion, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/782,381

(22) Filed: Jul. 24, 2007

(51) Int. Cl. G06Q 40/00

(52) U.S. Cl. 705/44; 705/35; 705/39

(57) ABSTRACT

A method for limiting debit card transactions includes establishing a limited debit card account linked to a financial funding account. A frequency period for funding the limited debit account and a maximum holding amount for the limited debit account are established by an individual. A debit card linked to the limited debit account is issued to the individual for making withdrawals and purchases. Based on a predetermined method and time period interest is paid by the entity maintaining the limited debit account, to the individual. Also, upon expiration of the frequency period funds are transferred from the financial funding account to the limited debit account to return the limited debit account to the designated maximum holding amount.

### BACKGROUND OF THE INVENTION

This invention is directed toward a system for a limited debit card account, and more particularly, a debit card account where a limit on the amount withdrawn over a specified period of time is predetermined.

Debit cards are well known in the art and typically are tied to an individual's checking account. The debit card allows the individual to make withdrawals from the checking account through an ATM machine, and to make a purchase at a point of sale where funds are transferred from the checking account to a merchant.

While debit cards provide convenience for individuals and a more immediate transfer of funds, there remain areas where a debit card system can be improved. For example, the financial institution that maintains the individual's checking account incurs some exposure to overdrafts. Because an individual, in addition to debit card withdrawals and purchases, is also making payments with checks, when funds are authorized and distributed through debit card transactions, there may be outstanding checks that exceed the funds in the account and lead to overdrafts. For the individual, checking accounts typically pay little if any interest. Therefore, a need exists in the art for a debit card system that addresses these deficiencies.

An objective of the present invention is to provide a debit card system that protects financial institutions from the risk of overdrafts.

Another objective of the present invention is to provide a debit card system that provides additional benefits and incentives to individuals.

These and other objectives will be apparent to those skilled in the art based on the following disclosure.

### SUMMARY OF THE INVENTIONS

A method for limiting debit card transactions includes establishing a limited debit card account linked to a financial funding account. A frequency period for funding the limited debit account and a maximum holding amount for the limited debit account are established by an individual. A debit card linked to the limited debit account is issued to the individual for making withdrawals and purchases. Interest is paid by the entity maintaining the limited debit account, to the individual based on a predetermined method and time period. Also, upon expiration of the frequency period funds are transferred from the financial funding account to the limited debit account to return the limited debit account to the designated maximum holding amount.

### BRIEF DESCRIPTION OF THE DRAWINGS

FIG. 1 is a schematic view of the working environment for a limited debit account;

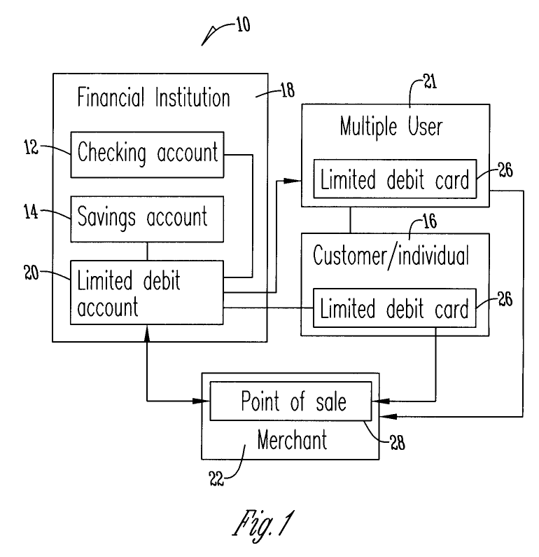

FIG. 2 is a schematic view of an alternative working environment for a limited debit account; and

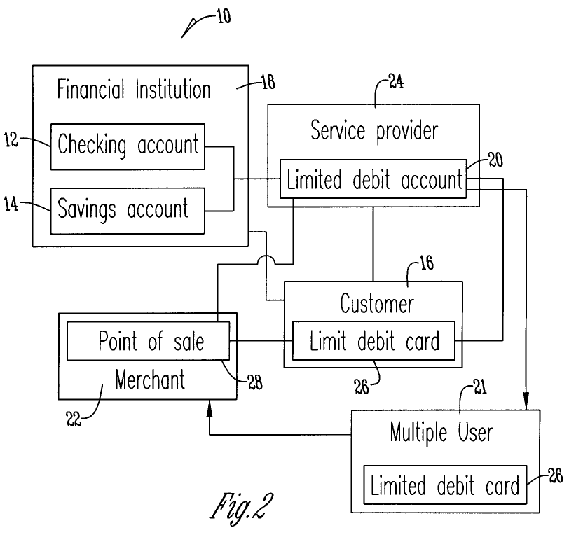

FIG. 3 is a flow diagram for a method for limiting a debit card transaction.

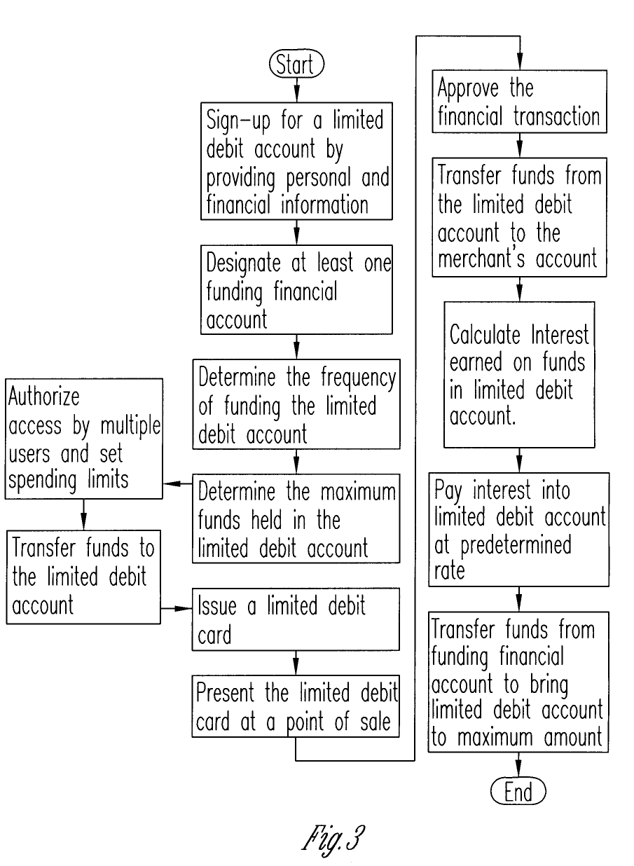

### DETAILED DESCRIPTION OF THE PREFERRED EMBODIMENTS

The limited debit card system 10 includes a checking 12, savings 14, and/or other financial account (i.e., money market account, etc.) where funds are maintained for an individual/customer 16 by a financial institution 18 such as a bank, credit union, broker or the like. By way of example only this description outlines the system as used with a magnetic debit/payment card. The system, however, can be used with other payment technologies such as chips embedded in plastic cards and the like without diverting from the scope or intent of the invention.

When desired the individual 16 requests that a limited debit account 20 be created and linked to at least one of the individual's financial accounts such as the individual's checking 12 and/or savings account 14. The limited debit account 20 is created and maintained by a financial institution 18, a merchant 22, and/or an independent service provider 24. The limited debit account 20 is located at the entity that maintains the individual's financial accounts or a separate financial entity. To provide an incentive for the individual to create a limited debit account the entity maintaining the account preferably offers an interest rate greater than that offered in other financial accounts. To create a limited debit account 20, the individual 16 either in person or over an electronic network identifies at least one or more of the individual's financial accounts 12, 14 from which funds will be withdrawn. The individual could also establish an automatic deposit of all or a portion of the individual's paycheck or other funds sources to the limited debit account 20.

The individual 16 also authorizes the frequency of the fund transfer for a desired time period such as weekly, twice a month, monthly, quarterly or yearly. The frequency options preferably are set by the service provider or the financial institution and then authorized by the individual. Finally, the individual 16 authorizes the maximum amount that the limited debit account 20 is to hold.

In addition, the individual 16 may authorize an automatic transfer from the funding account when the limited debit account 20 is over the authorized limit or there are insufficient funds to pay an automatic payment. Also, the individual may authorize a transfer from the funding account of an amount less than the funding amount when there are insufficient funds to meet the requested transfer amount.

In an alternative embodiment, an individual 16 authorizes access to the limited debit account 20 for multiple users 21. In authorizing multiple users 21, the individual 16 authorizes a time frame and spending limits for each additional user 21. For example, an individual/husband 16 establishes a limited debit account 20 authorizing that the account be funded $25,000 on a monthly basis. The husband 16 then authorizes access to the account for multiple users 21 (i.e., wife, college student, high school student). The husband then sets spending limits for specific time frames for each user 21. A single limit, or multiple limits (i.e., daily and weekly may be set). The following chart outlines one scenario:

| Card | Weekly Limit | Daily Limit |
|---|---|---|
| Husband | $1,000 | $300 |
| Wife | 1,000 | 300 |
| College Student | 250 | 50 |
| H.S. Student | 100 | 20 |

Once a limit is reached, access will be denied until the time period is expired.

Once the limited debit account 20 is established and approved funds are transferred from the authorized financial account(s) 12, 14 to the limited debit account 20 and a limited debit card 26 is issued to the individual 16. If multiple users 21 have been authorized, multiple limited debit cards 26 will be issued with each having a unique card number. The limited debit card 26 is issued by the financial institution 18, the merchant 22, or the independent service provider 24 and may not be the same as the entity that is maintaining the limited debit account 20.

Upon issuance, the individual uses the limited debit card 26 to make withdrawals and/or purchases at various points of sales 28 which include, but are not limited to retail merchants, ATM machines, and Internet merchants. Upon presentation of the debit card 26, through an electronic network, provided funds are available and proper authorization information is provided, the transaction is approved. Once approved, funds are transferred into a merchant's bank account.

The entity that is maintaining the account 20 pays into the account 20 interest at a predetermined rate. Preferably, the rate of interest will be based upon a calculation method selected by the entity maintaining the account. Also, the entity that is maintaining the account will select any method and time period for calculating and paying the interest. When the frequency period expires, funds are also transferred from the individual's financial account 12, 14 to bring the limited debit account back to its maximum amount.

Therefore, through this disclosure a system for a limited debit card account has been disclosed that at the very least reduces the risk of overdrafts and provides an incentive and benefit to the individual to sign-up and use a limited debit account.

What is claimed is:

1. A method for placing limits on debit card transactions, comprising the steps of:
establishing a limited debit card account that is linked to a funding financial account;
establishing a frequency for funding the limited debit card account;
establishing a maximum amount set by an individual to be funded to the limited debit card account; and
issuing a limited debit card linked to the limited debit account.

2. The method of claim 1 further comprising the step of presenting the limited debit card at a point of sale to make a financial transaction.

3. The method of claim 2 further comprising the step of approving the financial transaction.

4. The method of claim 1 further comprising the step of calculating an amount of interest earned for the limited debit account.

5. The method of claim 4 further comprising the step of paying interest into the limited debit account based on the calculated interest.

6. The method of claim 1 further comprising the step of transferring the maximum amount to be funded to the limited debit account from the funding financial account.

7. The method of claim 6 further comprising the step of transferring funds from the funding financial account to the limited debit account upon expiration of the frequency period to return the limited debit account to the established maximum amount.

8. The method of claim 1 further comprising the step of authorizing access by multiple users to the limited debit card account.

9. The method of claim 8 further comprising the step of setting at least one spending limit for each multiple user.

10. The method of claim 8 further comprising the step of issuing a limited debit card having a unique number to each multiple user.

11. The method of claim 1 further comprising the step of authorizing automatic transfer of funds from the funding financial account to the limited debit account when insufficient funds are in the limited debit account to fund a transaction.

12. The method of claim 1 further comprising the step of transferring funds less then the established maximum amount from the funding financial account to the limited debit account when insufficient funds are in the funding financial account to bring the limited debit account to the established maximum amount.
